(19) United States
(12) Patent Application Publication
(10) Pub. No.: US 2004/0118801 A1
(43) Pub. Date: Jun. 24, 2004

(54) Fully vented wide rim nursing bottle

(76) Inventors: Craig E. Brown, Mt. Zion, IL (US); Robert J. Brown, Chesterfield, MO (US); Bernard Kemper, Bonne Terre, MO (US)

Correspondence Address: Paul M. Denk, 763 South New Ballas Road, St. Louis, MO, 63141, US

(21) Appl. No.: 10/283,878

(22) Filed: Oct. 30, 2002

(51) Int. Cl. A61J 9/00; A61J 11/02

(52) U.S. Cl. 215/11.1; 215/11.5; 215/11.4

(57) ABSTRACT

A nursing bottle (1) formed of a large volume container, incorporating a vent tube (3) that extends inwardly of the container, having a vent port (4) arranged approximately at the volumetric midpoint (12) of the container, so as to allow for venting of pressure, whether of excessive or vacuum, to the atmosphere, at all times. The volumetric capacity of the nursing bottle container may be formed of a spherical shape (1), hemispherical shape (40), cylindrical shape (18), or to other configurations that provide for the internal volumetric capacity so that any formula placed therein will be prevented from blocking the vent port (4), the vent tube (3), regardless of the angular disposition undertaken by the nursing bottle during usage. The vent tube (10), with its disposed vent port (12), may either extend upwardly within the container, or extend downwardly (3) from its connection with the vent insert (7), operatively associated with a collar (6), that holds both the vent structures and the nipple (5) to the wide rimmed opening (19) for these type containers. In addition, as an alternative, the vent tube may be integrally formed, or connected by a flange, through the surface of the nursing bottle container, either at its bottom (14), or along a side (74), and either extend upwardly, or obliquely radially inwardly (82), so as to dispose its vent port (84)at that desired location approximately at the volumetric midpoint of the nursing bottle.

### CROSS REFERENCE TO RELATED APPLICATIONS

This application was filed in the PCT, with an international filing date of May 4, 2001. The international application No. is PCT/USO1/14365. It claims priority on an earlier U.S. provisional application dated May 8, 2000 having Ser. No. 60/202,851.

### BACKGROUND OF THE INVENTION

This invention relates generally to a nursing bottle, that incorporates enhanced features and parameters that provide for its full venting during both usage and storage.

Nursing bottles of a multitude of designs are available in the prior art. In many instances, as is well known in the art, frequently a vacuum will be generated within the bottle during dispensing of its contents, as when nursing the infant, and which is believed can cause various physiological impairments to the child when subjected to this type of condition over prolonged feedings. It is theorized that the vacuum generated within the bottle, due to the infant's sucking, can cause pressure imbalance at the location of various features of the body, such as in the ear canal, or perhaps elsewhere, and which may possibly lead to the generation of infection, illness, or other predicaments. Thus, the presenting of a nursing bottle that incorporates air venting means, so as to prevent the creation of a vacuum inside the bottle, has been considered a desirable development in the field of infant serving products. Such can be seen in the applicants' prior U.S. Pat. No. 5,779,071 and No. 5,570,769, wherein the reservoir tube that provides for venting, externally of the bottle cap, at an upper proximity, extends into the lower portion of the container, to function as a vent while the contents of the bottle are being consumed, when partially or fully inverted.

Other attempts have been made to provide a nursing bottle with an air vent, to enable the ambient air to enter the container during usage, and to dilute or prevent the generation of any vacuum. For example, the U.S. Pat. No. 598,231, to Roderick, discloses one such nursing bottle with a U-shaped air tube. Other patents show related types of technology, and provide means for venting air from the interior of its shown container, as can be seen in the U.S. Pat. No. 927,013 to Van Cleave. In addition, the U.S. Pat. No. 1,444,623 to Davenport, in addition to the prior U.S. Pat. No. 2,061,477 to Perry, show other means for venting of air from within a nursing bottle.

The current invention, on the other hand, provides means for venting of any air pressure within the bottle, and to prevent the generation of any vacuum or pressure therein, regardless whether the nursing bottle is being used, stored in an upright position, or partially or fully inverted as during consumption of its contents.

Other United States patents that relate to the subject matter of this invention include the U.S. Pat. No. 189,691 to Briere; U.S. Pat. No. 345,518, to Lelievre; U.S. Pat. No. 679,144, to Hardesty; U.S. Pat. No. 834,014, to Lyke; U.S. Pat. No. 1,600,804 to Donaldson; U.S. Pat. No. 2,156,313, to Schwab; U.S. Pat. No. 2,239,275, to Schwab; U.S. Pat. No. 2,610,755, to Gits; U.S. Pat. No. 2,742,168, to Panetti; U.S. Pat. No. 2,744,696, to Blackstone; U.S. Pat. No. 3,059,707, to Wilkinson, et al; U.S. Pat. No. 5,570,796, to Brown, et al. In addition British patent No. 273,185; and, British patent No. 454,053, show related development.

### SUMMARY OF THE INVENTION

This invention contemplates the establishment of a structured relationship between the container or vessel that holds the formula for a nursing bottle, having sufficient size so that as the formula is prepared and deposited within the container, its surface will be arranged below the vent port or the vent leading towards the exterior of the container, for venting purposes, and in addition, even when the vessel is inverted, by the infant or parent, during feeding, the liquid formula still will be maintained at a surface level below the vent port, but in this case, when in the inverted condition. Thus, the concept of this invention is to provide a container with sufficient bulk and volume, so that the formula or milk as supplied therein, whether it be in the four ounce, six ounce, eight ounce, plus category, will always leave the identified vent port exposed to attain the attributes of venting, for the nursing bottle, at all times.

Thus, no appreciably positive or negative pressure can build up in the container, since the vent port will be opened, for exhausting purposes, when the nursing bottle is maintained in an upright direction, as while it is being warmed or heated, in preparation for a feeding, and even while the bottle may be inverted, as during a feeding, so as to allow for the venting of any reduced pressure, internally generated within the container, that may occur as a result of the sucking action of the infant, during feeding.

This feature of providing sufficient internal volumetric size to the container is achieved through usage of containers that are of excessive dimensions, such as being large and spherical in shape, or cylindrical in shape and flattened upon each surface, or which has a size equivalent to that of a Mason jar. In one instance, the container may be shaped in a spherical form. In another embodiment, the container will be of a cylindrical shape, but be flattened or pancacked on the sides, as can be understood. In a further embodiment, the container may be of the jar shape, or even contain some concavity upon its sides, to facilitate its lifting. In addition, where the spherical or cylindrical type of container is used, it may have a flattened bottom, to add stability to the nursing bottle, when rested upon a surface.

In the preferred embodiment, the venting port cooperates with a vent tube, and lateral vent slots, that are built into the insert that is secured to the top of the container by means of its associated threaded collar, that holds both the vent tube within the vessel, and the conventional nipple, in place. The vent port associated with the vent tube may open directly, downwardly into the vessel, or it may have said lateral ports, to either side, so as to prevent the entrance of any formula, into the vent tube, as the container is being inverted during usage, but still allow the necessary venting.

In a further embodiment, the container, collar, and nipple may be of the conventional type, but having the volumetric sizes from the shaped containers as previously explained, but the vent tube and port may extend through the surface of the container, rather than cooperate with the collar, in the manner as previously described in U.S. Pat. No. 5,779,071.

Nevertheless, the orientation of the vent port, at its entrance point, leading to the vent tube, will normally be arranged somewhere centrally of the configured container, regardless what shape or structures the containers may possess, so as to allow the formulation to either be below the vent port, or above it, as the nursing bottle is either at rest, or being inverted as during usage, in the manner as previously explained.

Thus, it is the principal object of this invention to provide a volumetric sized container for use as a nursing bottle, and which incorporates a vent tube with vent port that is arranged approximately centrally thereof, so that the vent port avoids coverage from any of the formula or milk contained therein, either during usage when feeding the infant, or during nonusage when the bottle has been set on its base, as during storage, while heating, or when at rest.

A further object of this invention is to provide for structure means within a nursing bottle that provides for continuous venting of any pressure or vacuum generated within its container, regardless of usage or nonusage of the subject bottle.

Still another object of this invention is to provide for the structure of a wide rimmed collar for use with a standard wide mouth container as structured into a nursing bottle, and useful for feeding formula to an infant.

These and other objects may become more apparent to those skilled in the art upon review of the summary of the invention as provided herein, and upon undertaking a study the of the description of its preferred embodiment, in view of the illustrated drawings.

### BRIEF DESCRIPTION OF THE DRAWINGS

In referring to the drawings, FIG. 1 is a top view of a spherical shaped nursing bottle;

FIG. 2 is a side view thereof;

FIG. 2A is a side view of the bottle during usage;

FIG. 3 shows a modification to a spherical shaped nursing bottle wherein the vent tube extends structurally upwardly from its bottom;

FIG. 4 is a side view of the nursing bottle of FIG. 3;

FIG. 5 is a back view of the nursing bottle of FIG. 3;

FIG. 6 is a top view thereof;

FIG. 7 is a side view of a modified form of nursing bottle having a wide rim configuration for mounting of its collar and nipple, and supporting the vent structure therein;

FIG. 8 is a side view of the container for the nursing bottle as shown in FIG. 7;

FIG. 9 is an exploded view of the operative components of the structured nursing bottle as shown in FIG. 7;

FIG. 10 is a front view of a wide structured nursing bottle of a rectangular configuration having its collar and nipple applied to a wide rim at its upper end;

FIG. 11 is a top view thereof;

FIG. 12 is a bottom view thereof;

FIG. 13 is a side view thereof, and showing its internal venting structure;

FIG. 14 is a top view of the vent insert applied within the collar when affixed to the wide rim of the container of the nursing bottle as shown in FIG. 13;

FIG. 15 is a sectional view of the vent insert, taken along the line 15-15 of FIG. 14;

FIG. 16 is a front view of a nursing bottle having a volumetric structured vessel with the collar, vent insert and nipple applied to its wide rim top, for disposing its vent tube, and vent port approximately centrally of its shown container;

FIG. 17 is a front view of another spherical form of container for a nursing bottle having the vent tube operatively structured and disposed with its bottom segment;

FIG. 18 is a front view of a further rectangularly shaped volumetric sized container for a nursing bottle having the collar, vent insert, and vent tube all operatively associated therewith;

FIG. 19 is a top view of a further modified wide rim nursing bottle of this invention;

FIG. 20 is a front view thereof;

FIG. 21 is a further modified wide rim nursing bottle of this invention having its vent tube extending inwardly towards centrally from the upper container surface;

FIG. 22 is a further modified wide rim nursing bottle having its oblique vent tube extending inwardly from the approximate upper surface of its container;

FIG. 23 is a further modified wide rim nursing bottle having the vent tube extending inwardly from the surface of its container;

FIG. 24 is similar to the bottle of FIG. 22, with the vent tube structured further downwardly along the side of the shown bottle;

FIG. 25 is a front view of a further shaped vented nursing bottle of this invention; and

FIG. 26 is a top view of an oval shaped wide rim nursing bottle of this invention.

### DESCRIPTION OF THE PREFERRED EMBODIMENT

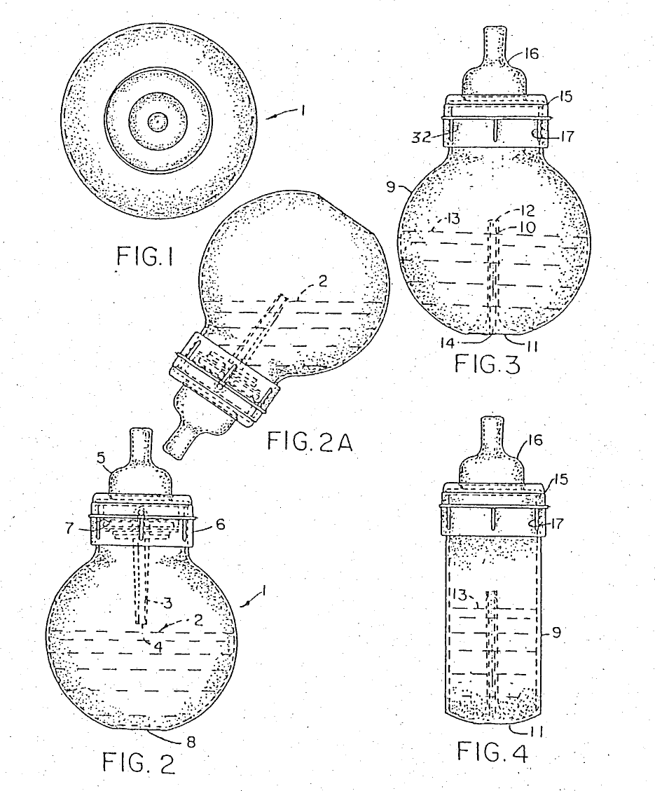

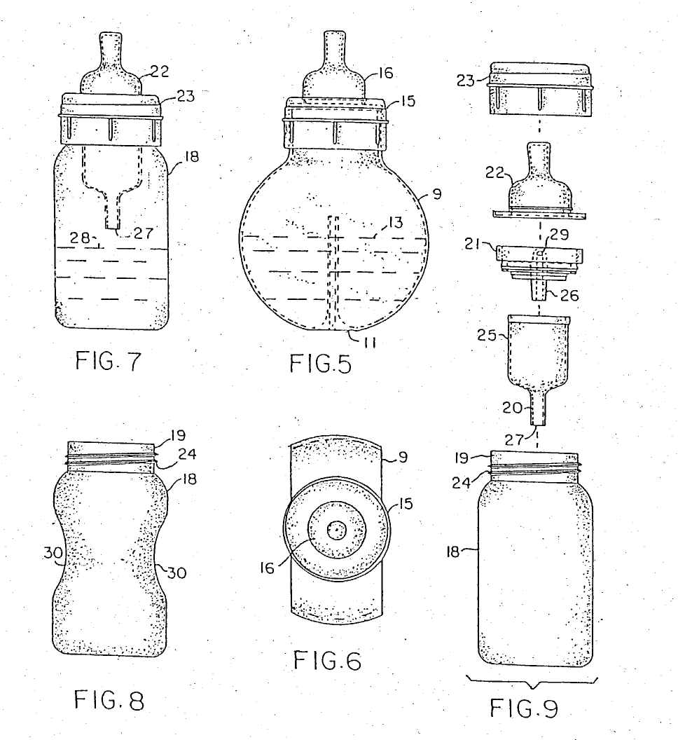

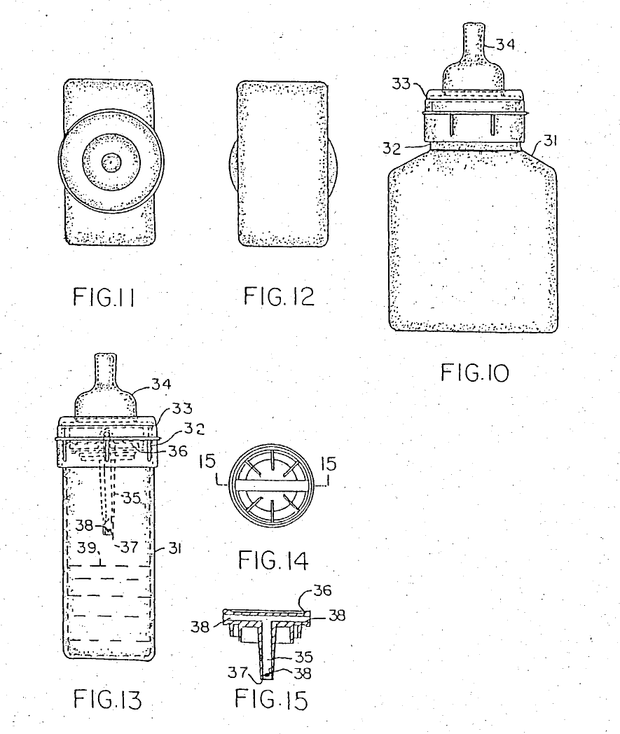

In referring to the drawings, and in particular FIGS. 1 and 2, the fully vented, wide rim nursing bottle of this invention is disclosed. It includes a spherical shaped container 1 that has ample volumetric capacity therein, so as to achieve the sought after results for this invention. That is, when a formula, such as at 2, is applied into the container, with the formula being applied at an amount that normally furnishes a feeding for the infant, it will only fill the container up to a level that is yet below the bottom of the vent tube 3, and more specifically its vent port 4, as can be noted.

Thus, when the nursing bottle is being heated, and should any pressure build up within its container, it will be immediately vented to the atmosphere, because of the openness of the vent port 4, to absorb any generated pressure, no matter how slight, and allow it to be vented to the atmosphere, externally of the shown nursing bottle. The nipple 5, the threaded collar 6, and the vent insert 7, that are threadedly applied to the upper edge of the container 1, are all fabricated in the manner as previously described in the U.S. Pat. No. 5,779,071, with the exception that these components are fabricated of a wider dimension, so as to fit upon a wide rim style of opening for the shown container 1, thereby providing the type of ample volumetric capacity for the nursing bottle, even though the standard size of nipple may be employed, to achieve the relationship between its structure, such as the vent port, and the level of any standard amount of formulation applied therein, during usage, to achieve the benefits of this invention. In addition, when the nursing bottle of this invention is applied, for feeding and infant, and is inverted, the formulation may rise to the opposite side of the inverted container 1, but yet will have a surface level that will still be below the vent port 4, so that any sucking action generated by the infant, during feeding, and the formation of any vacuum, or partial thereof, within the container, during feeding, will be continuously vented by its vent port 4, through the vent tube 3, and out of the vent insert 7, as previously reviewed. It should be noted that the container 1 of this invention will obviously include a minor flattened surface, as at 8, at its bottom, in order to facilitate the free standing of this nursing bottle, as when not in use, when stored, or when being warmed or heated in preparation for consumption of its formulated content.

FIG. 2A shows the container 1 and its nursing bottle when inverted, as during a feeding, to disclose how the fluid level 2 will yet remain below the opened vent port 4, so as to not obstruct the venting of any partial vacuum generated therein, during the feeding process.

FIGS. 3 and 4 disclose a modification to the shape of the container 9 for the shown nursing bottle, with the further modification that the vent tube 10 will be integrally structured with the bottom 11 of the shown container, disposing its vent port generally centrally of the container, as can be noted at 12. Thus, regardless at what position the container 9 of this nursing bottle may undertake, the surface level 13 of the formula will not obstruct the entrance of any generated vacuum or pressure into the vent port 12, for venting purposes, in this case, out of the bottom opening 14 of the shown vessel. This is so regardless whether the container 9, as during storage, or feeding, may be positioned vertically, as shown in FIG. 3, or inverted, as can be understood. In this particular instance, the threaded collar 15 and nipple 16 are conventional, and threadedly engage to the wide rim 17 of the container 9, in order to enhance the volumetric capacity of the nursing bottle, during usage, and to attain the results desired and required for this particular development. In addition, as can be seen in FIG. 4, the structure of wide rim container 9 is generally spherical, as can be noted in FIG. 3, but flattened on its front and back surfaces, as disclosed in FIG. 4, and yet attains the volumetric capacity for the formula, as desired and required for this development.

FIGS. 5 and 6 provide both a back view, and top view, of the modified nursing bottle as previously described in FIGS. 3 and 4.

FIGS. 7 through 9 show a further modified nursing bottle of this invention, wherein its container 18 has a Mason jar style of configuration, thereby affording the wide rimmed 19 style of opening, at its upper end, for accommodating the vent tube 20, receptacle portion 25, the vent insert 21, the nipple 22, and the threaded collar 23, that all threadedly engage onto the threads 24 of the shown container. These components 20 through 23 and 25 are very similar in structure to that as previously described in U.S. Pat. No. 5,779,071, with the exception that the components are fabricated to a wider dimension, in order to be accommodated upon the wide rimmed opening 19 of the shown container 18.

The vent tube communicates with its upper inner receptacle portion 25, forming the reservoir-like configuration as noted, and which positions thereon and locates therein the internal vent tube 26 of the vent insert 21, to function in the manner as previously explained in said earlier patent. But in this particular instance, it should be noted that the vent port 27 of the vent structure, as all mounted to the wide rim of the volumetric container 18, when inserted, is disposed approximately at the center of the internal space of the shown container 18, in order to achieve the benefits and results as explained for this invention. Hence, the surface level 28 of the formula applied therein will always be below the entrance to the vent port 27, so as to avoid its blockage, regardless whether the container 18 is maintained in its rest position, as shown in FIG. 7, or when the container is tilted to any angulation, or should it be inverted, placed on its side or any position, as during the feeding process. This allows the reduced pressure generated within the container, during feeding with the nursing bottle, to always be vented, to the atmosphere, as can be understood. In addition, it is to be noted, particularly upon review of U.S. Pat. No. 5,779,071, that wherever these vent tube and vent insert configurations are inserted upon the wide rim and held in position by means of the collar 23, that the vent tube 26 internally communicates with the lateral vent passages 29 and opens to atmosphere internally of the collar 23, to provided venting thereof, at all times, to achieve the purposes and advantages of this invention.

It can also be noted in FIG. 8 that the sides of the container 18 may be integrally concaved, as at 30, in order to facilitate the gripping and holding of the larger sized bottle, during its usage.

FIGS. 10 through 13 disclose a larger volumetric sized nursing bottle, having a container 31 that is generally of a rectangular configuration. It has a wide rimmed opening, as at 32 for accommodating the shown collar 33, its supported nipple 34, the vent tube 35, and the vent insert 36 when installed. The vent insert is shown more carefully in FIGS. 14 and 15, and it can be seen that the bottom of the vent port 37 is closed, and venting is achieved through the lateral port 38 that extends to the front and back of the vent tube, to attain venting from internally of the shown container. In addition, the lateral port 38 is arranged approximately at the volumetric midpoint of the bottle. In addition, the purpose of the lateral vents 38 is to prevent the entrance of any of the formula 39 therein, as when the nursing bottle is inverted, as during a feeding. Nevertheless, as can be seen in FIG. 13, the level of the formula will always be at a location spaced from the bottom of the vent tube 35, to attain the purposes of this invention. Furthermore, as can be seen in FIG. 15, and as noted from our prior patents, the vent insert 36 has the lateral vents 38 that communicate with the vent 35, for allowing the discharge of any vacuum, pressure, or the like, generated within the nursing bottle during usage, to the atmosphere, externally of the bottle, in order to achieve the benefits and results of this development.

FIG. 16 shows a nursing bottle that incorporates a semi-spherical container 40, and having mounted onto its integral wide rim 41 the collar 42, nipple 43, and the vent insert 44 as noted. In addition, the vent tube 45 extends downwardly into the container 40, with the bottom 46 of the vent tube being arranged approximately, once again, at the approximate midpoint of the volumetric capacity of the nursing bottle, to achieve the benefits of this invention.

FIG. 17 discloses a spherical form of nursing bottle wherein its container 61 has mounted to its wide rim 62 by threaded engagement the collar 63 and the nipple 64, as noted.

The vent tube, in this instance, as at 65, extends integrally upwardly from the bottom of the container 61, and internally is vented to the atmosphere, out the bottom of the bottle, and has at its upper end the lateral vent ports 66 as noted. Again, these vent ports are arranged at the approximate midpoint of the volumetric capacity for the shown container, to achieve the benefits of this invention.

FIGS. 18 and 19 disclose a modification to the nursing bottle of this invention, wherein its container 51 is generally rectangular of configuration in one dimension, but has an oval shape 52 along its vertical disposition. Its collar 53 supports the nipple 54, and the vent insert 55 to the wide rim 56 of the integral container 51, for the nursing bottle. The vent tube 57 of the insert extends downwardly, and includes an extended vent tube 58, whereby its vent port 59 at its bottom end is disposed approximately, once again, at the volumetric midpoint of the shown container 51 for the nursing bottle. Thus, any formula 60 contained therein, and processed for feeding, will always be below the disposition of the vent port 59, regardless whether the nursing bottle is rested upright, as shown in FIG. 18, or inverted, as during the feeding process.

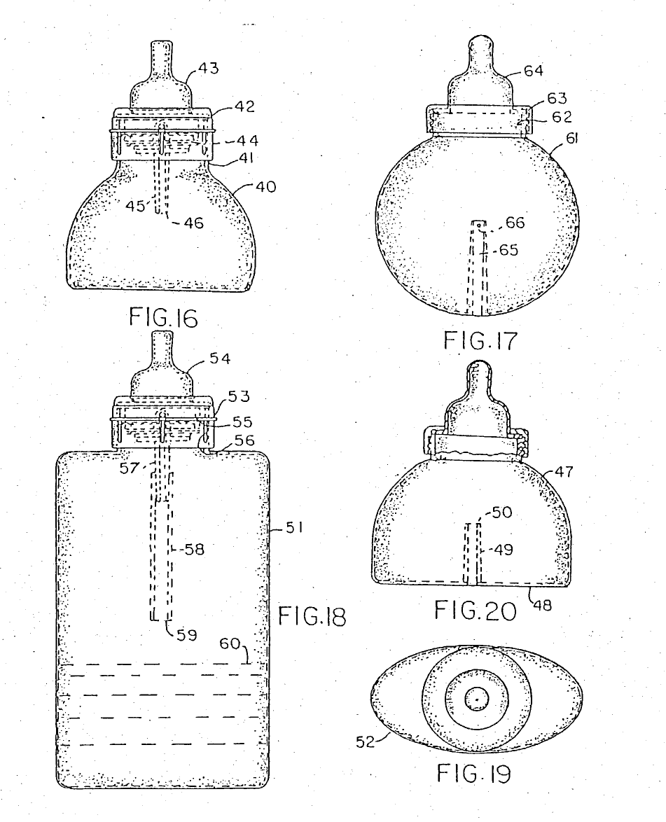

FIG. 20 shows a similar style of nursing bottle, to that of FIG. 16, but in this instance, its container 47 has integrally formed of its flattened bottom 48 an upwardly extending vent tube 49, whose upper end 50, forming the vent port, is arranged once again at the approximate volumetric midpoint of its shown container.

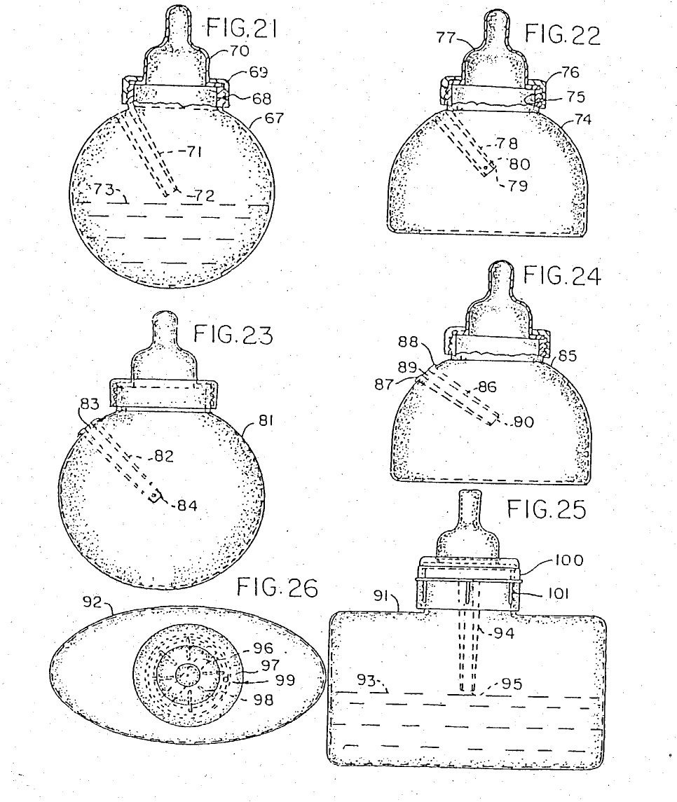

FIGS. 21 through 25 show variations upon the arrangement of the vent tube of this invention. As noted, in FIG. 21 the shown nursing bottle has its container 67 mounting upon its wide rim 68, its threaded collar 69, and the shown nipple 70. For venting purposes, in this particular embodiment, the vent tube 71 is integrally formed of the container 67, and extends radially inwardly, along an oblique angle, into the approximate midpoint of the shown container, having its vent port 72 disposed approximately at this location, as noted.

Thus, any formula 73 provided therein, and particularly of the standard amount normally fed to an infant, will always be below the entrance to the vent port 72, and not cause any blockage thereof. This is so regardless whether the nursing bottle is being stored, or inverted as during usage, as can be understood.

FIG. 22 shows the semispherical style of container 74 for the shown nursing bottle. The bottle has a wide rim 75, and to which the threaded collar 76 and the nipple 77 are attached.

In this instance, similar to that of the bottle as described in FIG. 21, the vent tube 78 is integrally formed of the container, and is arranged obliquely within it, to dispose its vent port, as at 79, and more specifically its lateral vents 80, internally at the approximate volumetric midpoint of the shown container, to achieve the benefits of this invention.

FIG. 23 is similar to the structured nursing bottle as described in FIG. 21, but in this instance, as can be noted, the container 81 has its vent tube 82 arranged further down the side of the shown container, opening to atmosphere as at 83, and having its vent port 84 provided at the approximate midpoint of the shown container 81.

FIG. 24 shows a structure for a nursing bottle similar to that as previously explained in FIG. 22, but in this particular instance, the container 85 has its vent tube 86 integrally formed further down the side of the shown container, as can be noted at 87. This may be integrally formed, or structurally applied thereto, as by adherence of the flanges 88 to the opening 89 provided through the wall of the container 85. The inner end of the vent tube 86, has its vent port 90, arranged, once again, at the approximate volumetric midpoint of the shown container, in order to achieve the results and benefits of this invention.

FIGS. 25 and 26 disclose a further modification to the nursing bottle of this invention, wherein its rectangularly configured container 91 has an oval appearance along the vertical, as can be noted in FIG. 26, as at 92.

It provides sufficient volumetric capacity so that the surface of the formula added thereto, as at 93, will always be below the vent tube 94, and its vent port 95, regardless of the position undertaken by the nursing bottle, when used. In accordance with the structure of the venting characteristics of this development, and as can be seen in FIG. 26, the vent tube 94 has lateral vents 96 that extend laterally to the sides of the vent insert 97, and which provides venting of any pressure or vacuum developed within the container 91 to the atmosphere, by passing through the configured threads 101, as can be understood from our prior patents.

As known from our prior development, the vent insert 97 includes a series of supporting vanes 98 that provide intermediate spacing, as at 99, and through which the formula may flow, when the nursing bottle is inverted, as during a feeding. But, the lateral vents 96 communicate with the vent tube 94, to allow passage of any pressure, or lack thereof, therethrough, and through said vents, to be discharged to atmosphere, by passing through the imperfect seal formed of the threaded connection between the collar 100, and the threads 101 of the wide rimmed structure of the container 91, of the shown nursing bottle. Nevertheless, the criticality regarding the location of the vent port 95, at the approximate volumetric midpoint of the shown container 91, is essential so as to prevent any blockage to it, when formula is applied therein, so that venting can effectively occur, regardless whether the nursing bottle is being used, stored, heated, or inverted, as during a feeding process.

Variations or modifications to the subject matter of this invention may occur to those skilled in the art upon reviewing the development as described herein. Such variations, if within the scope of this development, are intended to be encompassed within the principles of this invention, as explained herein. The description of the preferred embodiment, in addition to the depiction within the drawings, are set forth for illustrative purposes only.

1. A wide-rim, fully vented nursing bottle adapted to be filled with liquid, wherein the bottle prevents a vacuum from being formed within the bottle when tilted or inverted, the nursing bottle comprising:
a container having a wide-rim at an open top and being adapted to contain a quantity of liquid therein, said container having a volumetric capacity, and a volumetric center of the container;
a threaded collar, a nipple, and a vent insert, all cooperating together and capable of application to the open top of the wide-rim container to provide venting to the interior of the nursing bottle when used, the vent insert having a vent tube at its upper end connecting therewith, and the lower end of the vent tube terminating at the volumetric center of the container such that when the container is inverted any liquid therein remains below the bottom of the vent tube; and
an airway in the vent tube and communicating through the vent insert for venting externally of the bottle to the atmosphere when the nursing bottle is titled or inverted.

2. The nursing bottle according to claim 1 wherein the vent tube has an opening at its distal lower end.

3. The nursing bottle according to claim 2 wherein the opening at the lower end of the vent tube opens downwardly.

4. The nursing bottle according to claim 2 wherein the opening at the lower end of the vent tube ports laterally of said vent tube.

5. The nursing bottle according to claim 2 wherein the container is formed spherically.

6. The nursing bottle according to claim 2 wherein the container is formed hemispherically, the bottom of the hemispherically shaped container forming the base for the nursing bottle.

7. The nursing bottle according to claim 2 wherein the container is shaped cylindrically.

8. The nursing bottle according to claim 2 wherein the collar threadedly engages the wide rim of the nursing bottle.

9. The nursing bottle according to claim 8 wherein said collar, vent unit, and vent tube are integrally structured.

10. The nursing bottle according to claim 4 wherein the lower end of the vent tube is closed to reduce the flow of liquid therein during inverting of the nursing bottle during usage.

11. A wide-rim, fully vented nursing bottle adapted to be filled with liquid, wherein the bottle prevents a vacuum from being formed within the bottle when tilted or inverted, the nursing bottle comprising:
a container having a wide-rim at an open top and being adapted to contain a quantity of liquid therein, said container having a volumetric capacity, and a volumetric center of the container;
a threaded collar and a nipple all cooperating together and capable of application to the open top of the wide-rim container to provide discharge of the liquid when the nursing bottle is used;
said container formed of side and bottom walls, a vent tube at one end connecting to one of said walls, and said vent tube at its opposite end terminating at the volumetric center of the container such that when the container is inverted any liquid therein remains below the lower end of the vent tube; and
an airway in the vent tube and communicating therethrough for venting externally of the bottle to the atmosphere when the nursing bottle is tilted or inverted.

12. The nursing bottle according to claim 11 wherein the vent tube as its one end connects with a side wall of the nursing bottle.

13. The nursing bottle according to claim 12 wherein said vent tube is obliquely located within the structure of the nursing bottle.

14. The nursing bottle according to claim 12, wherein said vent tube at one end connects with the bottom wall of the nursing bottle, while the opposite end of the vent tube terminates at the volumetric center of the container.

15. The nursing bottle according to claim 12 wherein the container is formed hemispherically, the bottom of the hemispherically shaped container forming a base for the nursing bottle, a vent tube at one end connecting with the base of the hemispherically shaped container, while the vent tube at its opposite end terminates at the volumetric center of the container such that when the container is inverted any liquid therein remains below the bottom of the vent tube; and an airway in the vent and communicating through the vent tube and the wall of the bottle to vent externally of the bottle to the atmosphere when the nursing bottle is tilted or inverted during usage.

16. A wide-rim, fully vented nursing bottle adapted to be filled with liquid, wherein the bottle prevents a vacuum from being formed within the bottle when tilted or inverted, the nursing bottle comprising:
a container, said container having a wide rim at an open top and being adapted to contain a quantity of liquid therein, said container having a volumetric capacity;
a threaded collar, a nipple, and a vent insert all cooperating together and capable of application to the wide-rim of the open top of the container to provide venting to the interior of the nursing bottle when used, the vent insert having a vent tube at its upper end connecting therewith, and the lower end of the vent tube terminating proximate the bottom of the container such that when the container is inverted any liquid therein remains below the bottom of the vent tube; and
an airway in the vent tube and communicating through the vent insert for venting externally proximate the wide-rim of the bottle to the atmosphere when the nursing bottle is tilted or inverted during usage.

17. The nursing bottle according to claim 2 wherein at least one side of the nursing bottle is integrally concaved to facilitate its grasp.
